(19) United States
(12) Patent Application Publication
(10) Pub. No.: US 2025/0313405 A1
(43) Pub. Date: Oct. 9, 2025

(54) TOOL FOR DETECTING THE POSITIONING OF A CONTAINER HANDLING VEHICLE OF A STORAGE SYSTEM

(71) Applicant: AutoStore Technology AS, Nedre Vats (NO)

(72) Inventors: Trond Austrheim, Etne (NO); Ragnar Stuhaug, Skjold (NO); Ingvar Fagerland, Kolnes (NO); Sveinar Saeverud, Bømlo (NO); Kjell Inge Kjaerandsen, Haugesund (NO)

(21) Appl. No.: 18/860,321

(22) PCT Filed: Apr. 25, 2023
(86) PCT No.: PCT/EP2023/060829

§ 371 Date: Oct. 25, 2024

(30) Foreign Application Priority Data
May 2, 2022 (NO) 20220501

(51) Int. Cl. B65G 1/04; G01S 17/88

(52) U.S. Cl. CPC B65G 1/0464; B65G 1/0478; G01S 17/88; B65G 2203/041; B65G 2203/044

(57) ABSTRACT

A tool, a method, a computer program product and a system for detecting the positioning of a first container handling vehicle on a grid-based rail system of an automated storage and retrieval system, the rail system being part of a framework structure where the rail system comprises a first set of parallel rails arranged to guide movement of container handling vehicles in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members that define storage columns for storing containers within the framework structure, wherein the tool comprises an upper surface provided with formations to allow the tool to be picked up by a lifting device of a second container handling vehicle working on the rail system, the tool including a sensor for detecting the positioning of the first container handling vehicle on the rail system.

### TECHNICAL FIELD

The present invention relates to an automated storage and retrieval system for storage and retrieval of containers, in particular to a system an method for finding the location of a container handling vehicle that has faulty on the grid and escorting the faulty first container handling vehicle to a known location.

### BACKGROUND AND PRIOR ART

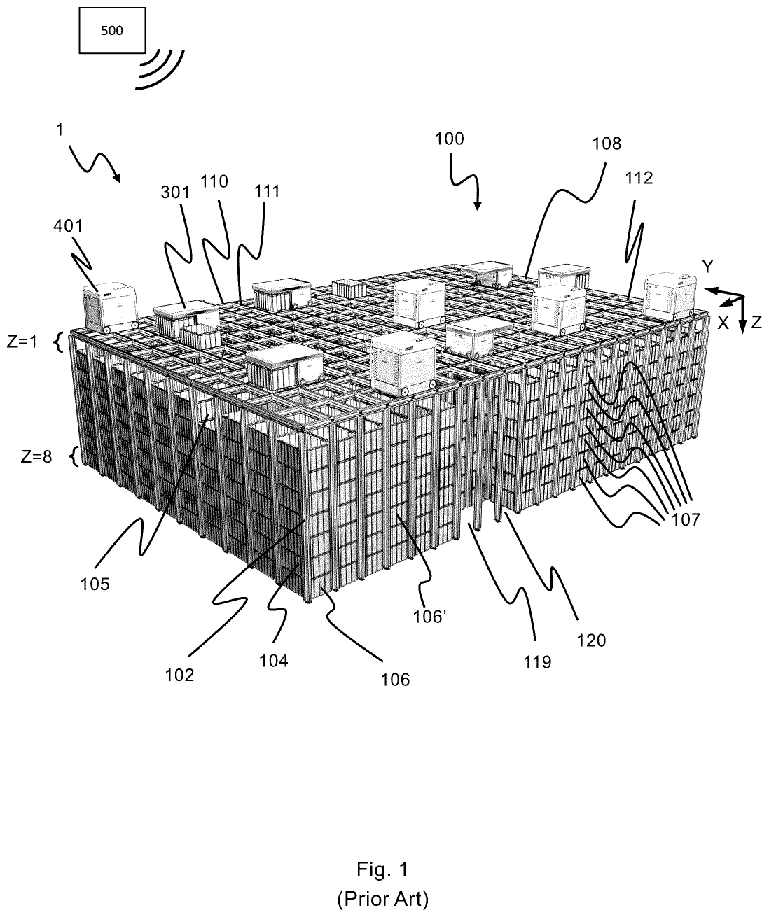

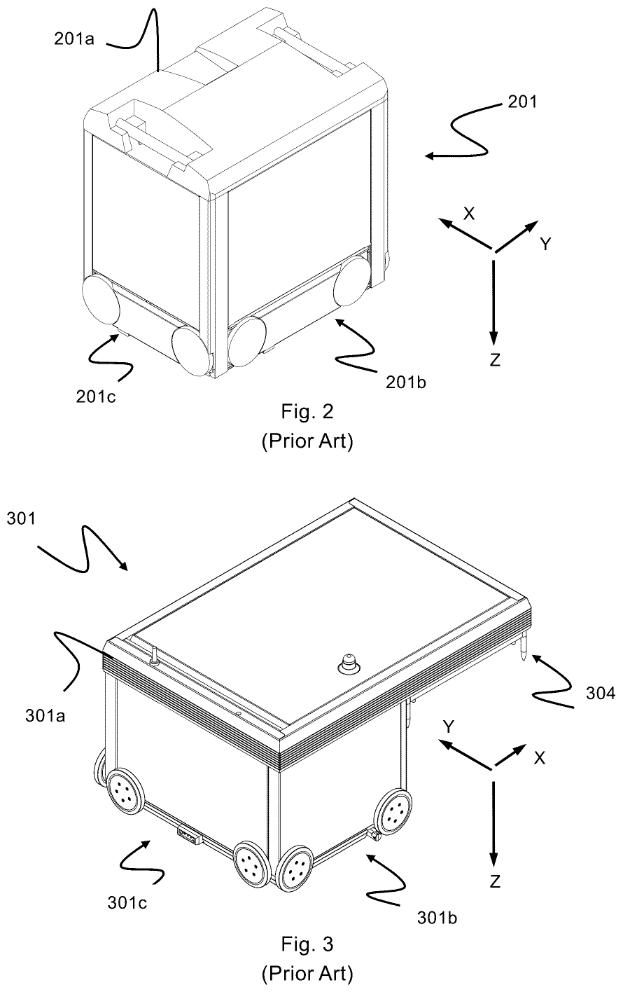

FIG. 1 discloses a typical prior art automated storage and retrieval system 1 with a framework structure 100 and FIGS. 2, 3 and 4 disclose three different prior art container handling vehicles 201,301,401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 201,301,401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 201,301,401 in a first direction X across the top of the frame structure 100, and a second set of parallel rails 111 arranged perpendicular to the first set of rails 110 to guide movement of the container handling vehicles 201,301,401 in a second direction Y which is perpendicular to the first direction X. Containers 106 stored in the columns 105 are accessed by the container handling vehicles 201,301,401 through access openings 112 in the rail system 108. The container handling vehicles 201,301,401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201,301,401 comprises a vehicle body 201a,301a,401a and first and second sets of wheels 201b,301b,201c,301c,401b,401c which enable the lateral movement of the container handling vehicles 201,301,401 in the X direction and in the Y direction, respectively. In FIGS. 2, 3 and 4 two wheels in each set are fully visible. The first set of wheels 201b,301b,401b is arranged to engage with two adjacent rails of the first set 110 of rails, and the second set of wheels 201c,301c,401c is arranged to engage with two adjacent rails of the second set 111 of rails. At least one of the sets of wheels 201b,301b,201c,301c,401b,401c can be lifted and lowered, so that the first set of wheels 201b,301b,401b and/or the second set of wheels 201c,301c,401c can be engaged with the respective set of rails 110, 111 at any one time.

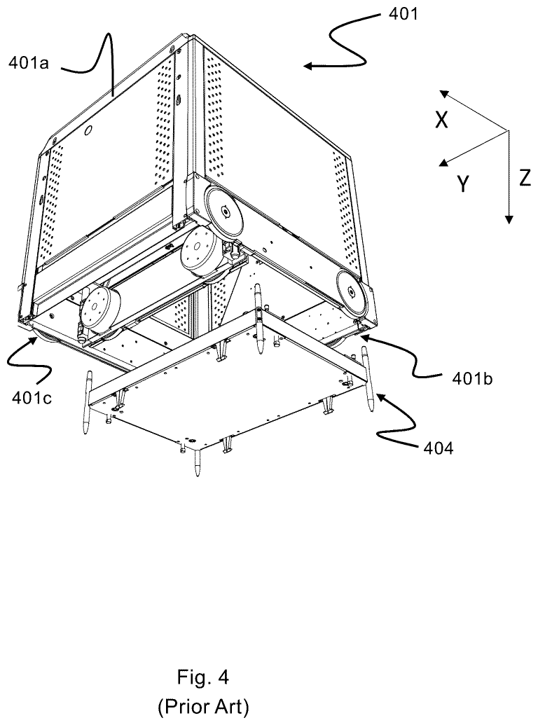

Each prior art container handling vehicle 201,301,401 also comprises a lifting device for vertical transportation of storage containers 106, e.g. raising a storage container 106 from, and lowering a storage container 106 into, a storage column 105. The lifting device comprises one or more gripping/engaging devices which are adapted to engage a storage container 106, and which gripping/engaging devices can be lowered from the vehicle 201,301,401 so that the position of the gripping/engaging devices with respect to the vehicle 201,301,401 can be adjusted in a third direction Z which is orthogonal the first direction X and the second direction Y. Parts of the gripping device of the container handling vehicles 301,401 are shown in FIGS. 3 and 4 indicated with reference number 304,404. The gripping device of the container handling device 201 is located within the vehicle body 201a in FIG. 2.

Conventionally, and also for the purpose of this application, Z=1 identifies the uppermost layer of storage containers, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=17, Y=1, Z=6. The container handling vehicles 201,301,401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201,301,401 comprises a storage compartment or space for receiving and stowing a storage container 106 when transporting the storage container 106 across the rail system 108. The storage space may comprise a cavity arranged internally within the vehicle body 201a as shown in FIGS. 2 and 4 and as described in e.g. WO2015/193278A1 and WO2019/206487A1, the contents of which are incorporated herein by reference.

FIG. 3 shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIGS. 1 and 4, e.g. as is disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201,301,401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119,120. The transportation to the access station may be in any direction, that is horizontal, tilted and/or vertical. For example, the storage containers 106 may be placed in a random or dedicated column 105 within the framework structure 100, then picked up by any container handling vehicle and transported to a port column 119,120 for further transportation to an access station. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201,301 can drop off storage containers 106 to be transported to an access or a transfer station, and the second port column 120 may be a dedicated pick-up port column where the container handling vehicles 201,301,401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1 but are returned into the framework structure 100 again once accessed. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119,120 and the access station.

If the port columns 119,120 and the access station are located at different levels, the conveyor system may comprise a lift device with a vertical component for transporting the storage containers 106 vertically between the port column 119,120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201,301,401 is instructed to retrieve the target storage container 106 from its position and transport it to the drop-off port column 119. This operation involves moving the container handling vehicle 201,301 to a location above the storage column 105 in which the target storage container 106 is positioned, retrieving the storage container 106 from the storage column 105 using the container handling vehicle's 201,301,401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201,301,401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201,301,401 is instructed to pick up the storage container 106 from the pick-up port column 120 and transport it to a location above the storage column 105 where it is to be stored. After any storage containers 106 positioned at or above the target position within the stack 107 have been removed, the container handling vehicle 201,301,401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106; and the movement of the container handling vehicles 201,301,401 so that a desired storage container 106 can be delivered to the desired location at the desired time without the container handling vehicles 201,301,401 colliding with each other, the automated storage and retrieval system 1 comprises a control system 500 which typically is computerized and which typically comprises a database for keeping track of the storage containers 106.

Several problems can emerge if a container handling vehicle breaks down on the grid. One problem is to recover the faulty container handling vehicle and the other is actually to locate the faulty container handling vehicle. This is actually a problem that can escalate quickly if the robot is not located quickly. The reason is that a container handling vehicle that has a fault can actually travel quite far before is stops and the central computer system does not know where the faulty container handling vehicle is, meaning that there is a high probability that other container handling vehicles can crash into the faulty container handling vehicle.

Even if the faulty container handling vehicle is located on the grid it still needs to be transported either to a destination that is known, like e.g. a cell on the grid, or to a service center for repairs. A common solution for this is that the entire grid may be shut down so that a person can go onto the grid to push the container handling vehicle back to the service area. This is costly and time consuming.

### SUMMARY

The present invention is set forth and characterized in the independent claims, while the dependent claims describe other characteristics of the invention.

In one aspect, the invention is related to a tool for detecting the positioning of a first container handling vehicle on a grid-based rail system of an automated storage and retrieval system, the rail system being part of a framework structure where the rail system comprises a first set of parallel rails arranged to guide movement of container handling vehicles in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members that define storage columns for storing containers within the framework structure, wherein the tool comprises an upper surface provided with formations to allow the tool to be picked up by a lifting device of a second container handling vehicle working on the rail system, the tool including a sensor for detecting the positioning of the first container handling vehicle on the rail system.

The sensor for determining the positioning of a first container handling vehicle can be placed on a side or the bottom surface of the tool, and the sensor can be a camera, a lidar, a proximity sensor or any other type of sensor capable of detecting objects surrounding it, also there can be more than one sensor attached to the tool.

The tool can have tool support fixtures on at least one side for pushing the first container handling vehicle to a known location.

The tool can have a wireless communication device, a power source, and a controller for performing measurements and communicating with a central computer system.

The tool can have a set of legs allowing the tool to be placed on the grid.

The tool support fixtures can rest on the rails around the grid cell when the tool is lowered into a grid cell.

The tool can have feet attached to it that rest in the tracks around the grid cell when the tool is placed on the grid.

In a second aspect, the invention concerns a method for detecting the positioning of a first container handling vehicle on a grid-based rail system of an automated storage and retrieval system, the rail system being part of a framework structure, the rail system comprising a first set of parallel rails arranged to guide movement of container handling vehicles in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members that define storage columns for storing containers within the framework structure, the method comprising: picking up the tool using a lifting device of a second container handling vehicle working on the rail system, transporting the tool to a location at least one cell away from the last known location of the first container handling vehicle, using the tool to determine the positioning of the first container handling vehicle, and telling the second container handling vehicle carrying the tool to place the tool back to its storage place.

Further, placing the tool and using it on the grid to monitor the situation in the rail system, also placing a plurality of tools around the grid.

In a third aspect, the invention concerns a system for detecting the positioning of a first container handling vehicle on a grid-based rail system of an automated storage and retrieval system, the rail system being part of a framework structure where the rail system comprises a first set of parallel rails arranged to guide movement of container handling vehicles in a first direction (X) across the top of the framework structure, and a second set of parallel rails arranged perpendicular to the first set of rails to guide movement of the container handling vehicle in a second direction (Y) which is perpendicular to the first direction (X), the first and second sets of parallel rails dividing the rail system into a plurality of grid cells, the framework structure comprising upright members that define storage columns for storing containers within the framework structure, wherein the system comprises a tool that can be carried by a container handling vehicle.

In a forth aspect, the invention concerns a computer program product comprising instructions which run on a computer which controls the system resulting in commands being sent to: instruct the second container handling vehicle to pick up the tool using a lifting device of the second container handling vehicle working on the rail system, instruct the second container handling vehicle to transports the tool to a location at least one cell away from the last known location of the first faulty container handling vehicle, instruct the second container handling vehicle using the tool to determine the positioning of the first faulty container handling vehicle, and instructing the second container handling vehicle carrying the tool to place the tool back to its storage place.

By using this solution, it is possible to find out where a faulty container handling vehicle is located on the grid when the central computer system knows where the faulty container handling vehicle is. Further it is possible to maneuver the faulty container handling vehicle to a known location or to a location where it can be serviced if it is not capable to start and run properly on its own.

### BRIEF DESCRIPTION

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having an internally arranged cavity for carrying storage containers therein.

FIG. 3 is a perspective view of a prior art container handling vehicle having a cantilever for carrying storage containers underneath.

FIG. 4 is a perspective view of a container handling vehicle with a central cavity solution.

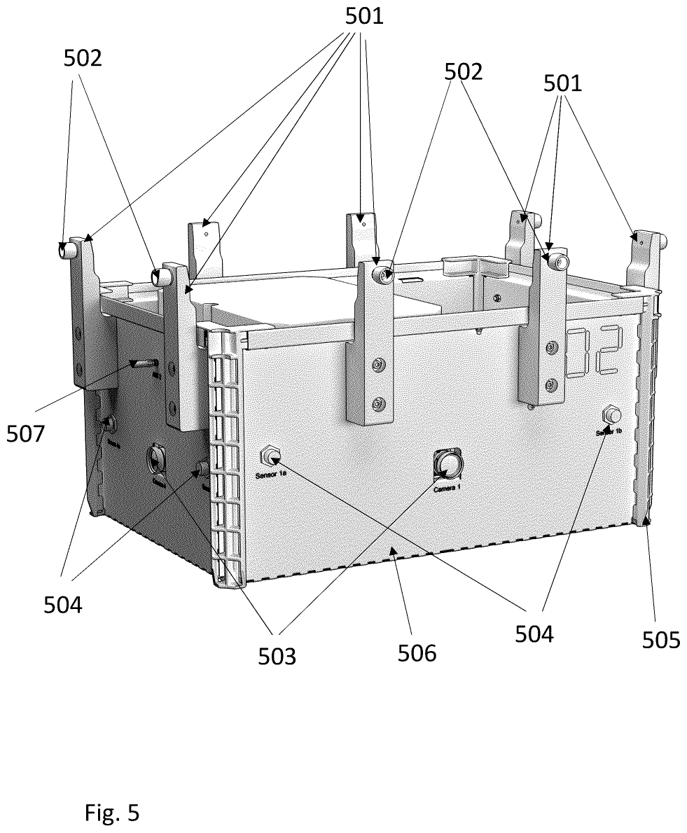

FIG. 5 is a perspective view of an embodiment of the present invention displaying the tool for detecting the positioning of a faulty first container handling vehicle on a grid-based rail system of an automated storage and retrieval system.

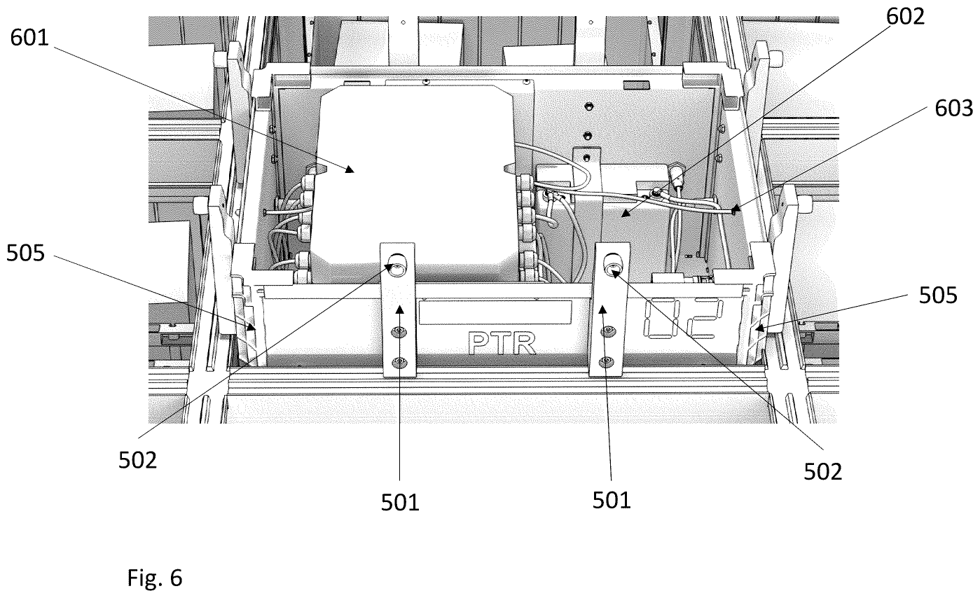

FIG. 6 is a perspective view of the embodiment from FIG. 5 displaying the equipment inside the tool.

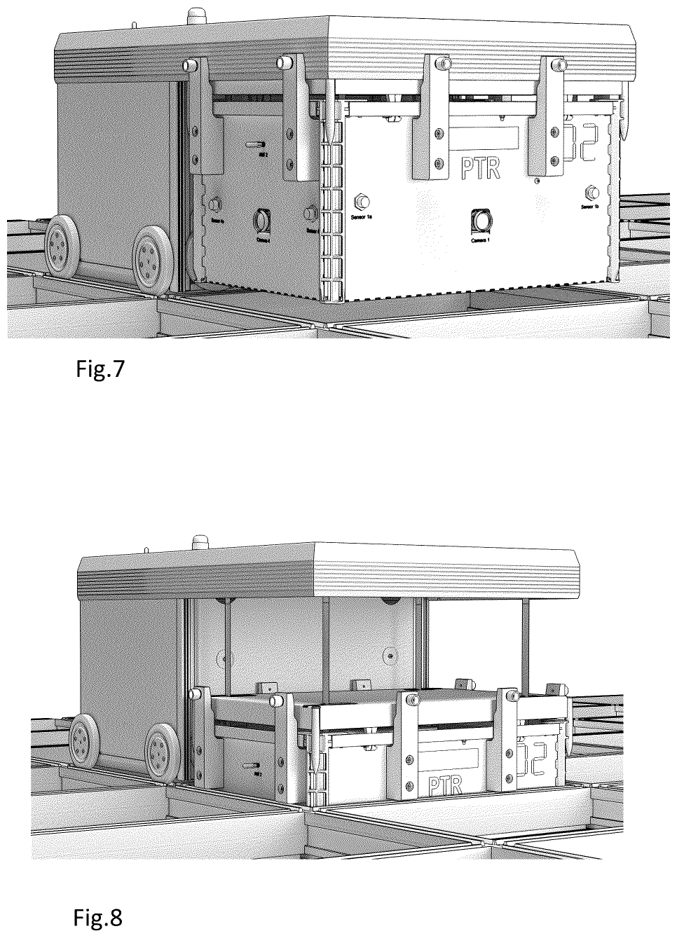

FIG. 7 is a perspective view of the tool according to the embodiment in FIG. 5 being carried by a container handling vehicle to a destination close to the area where a faulty first container handling vehicle has faulty.

FIG. 8 is a perspective view of the embodiment of the present invention according to FIG. 5 where the tool is placed in the grid of the automated storage and retrieval system.

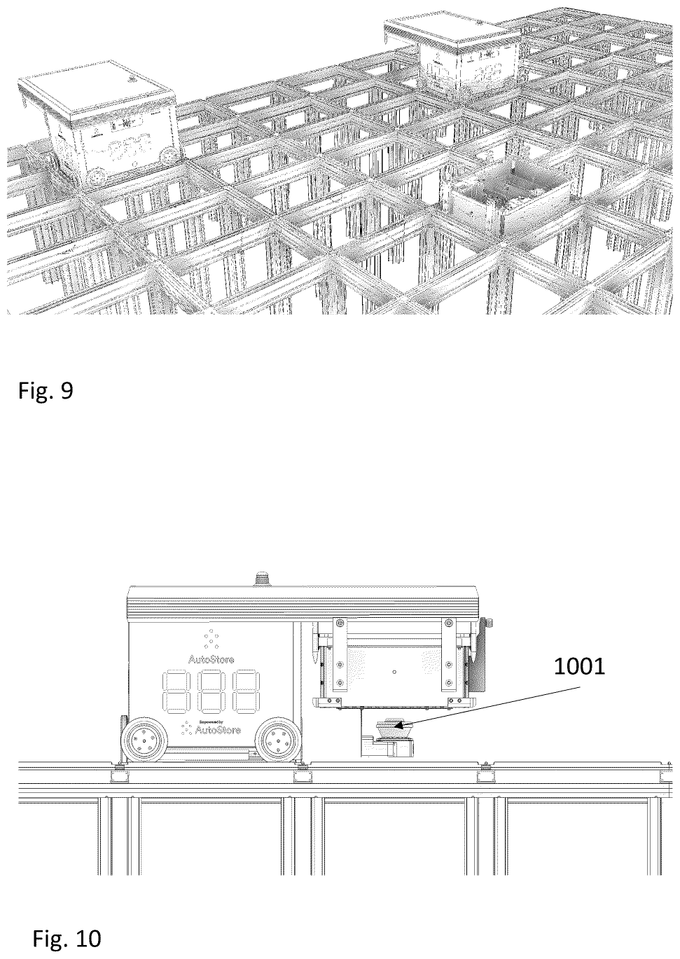

FIG. 9 is a perspective view of an embodiment of the present invention according to FIG. 5 wherein the tool is placed in the grid of the automated storage and retrieval system.

FIG. 10 is a side view of another embodiment of the present invention wherein the tool is carried by a container handling vehicle.

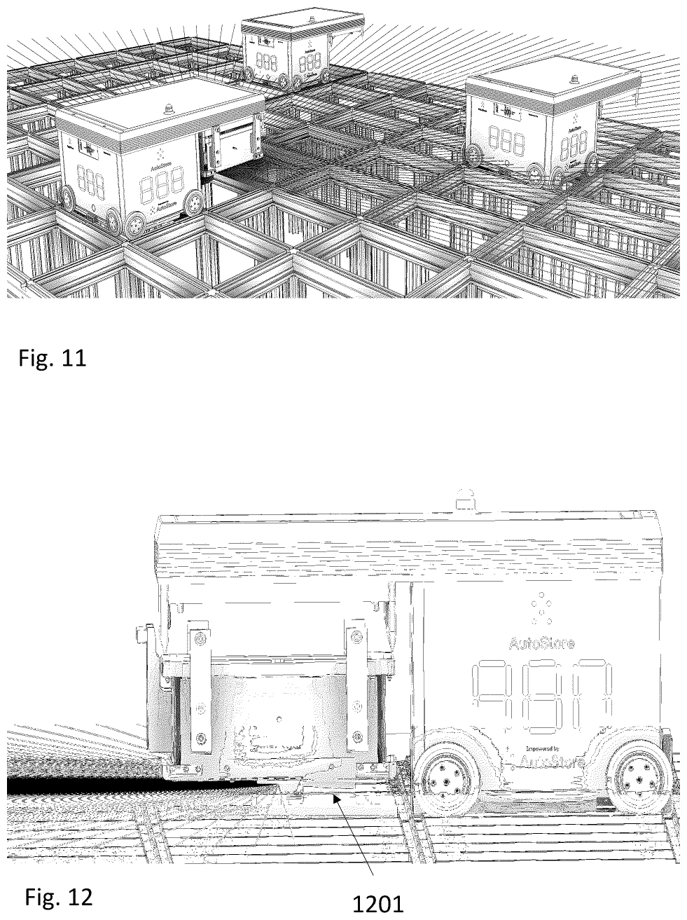

FIG. 11 is a perspective view of the present invention according to the embodiment from FIG. 10 wherein the tool is carried by a container handling vehicle when performing the measurements.

FIG. 12 is a side view of a third another embodiment of the present invention wherein the tool is carried by a container handling vehicle while performing the measurements.

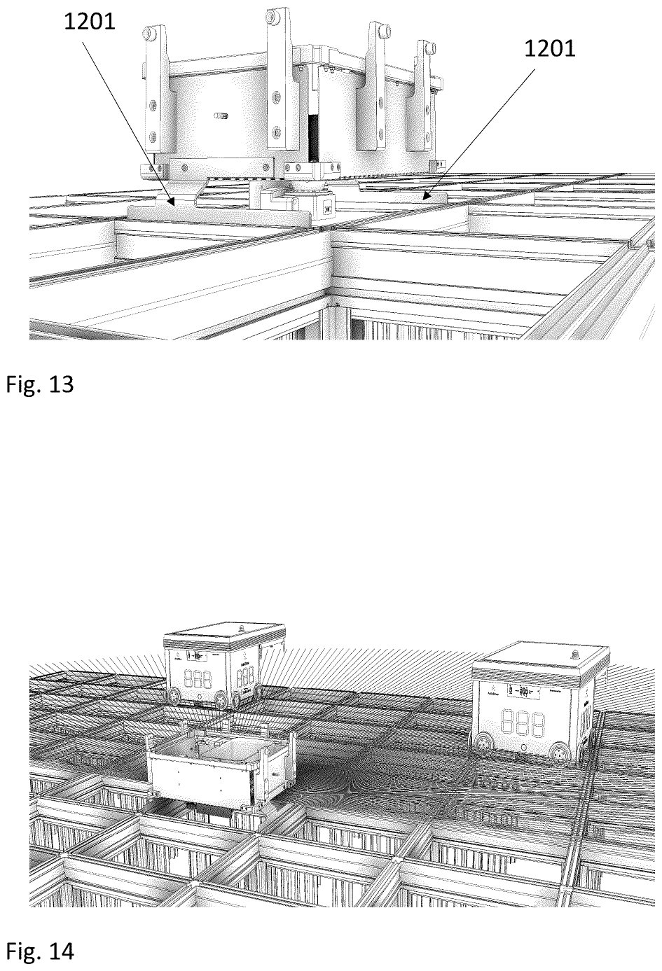

FIG. 13 is a side view of the embodiment of the present invention from FIG. 12 wherein the tool is positioned on the grid of the automated storage and retrieval system.

FIG. 14 is a perspective view of the third embodiment of the present invention wherein the tool is placed on the grid of the automated storage and retrieval system while the tool is performing the measurements.

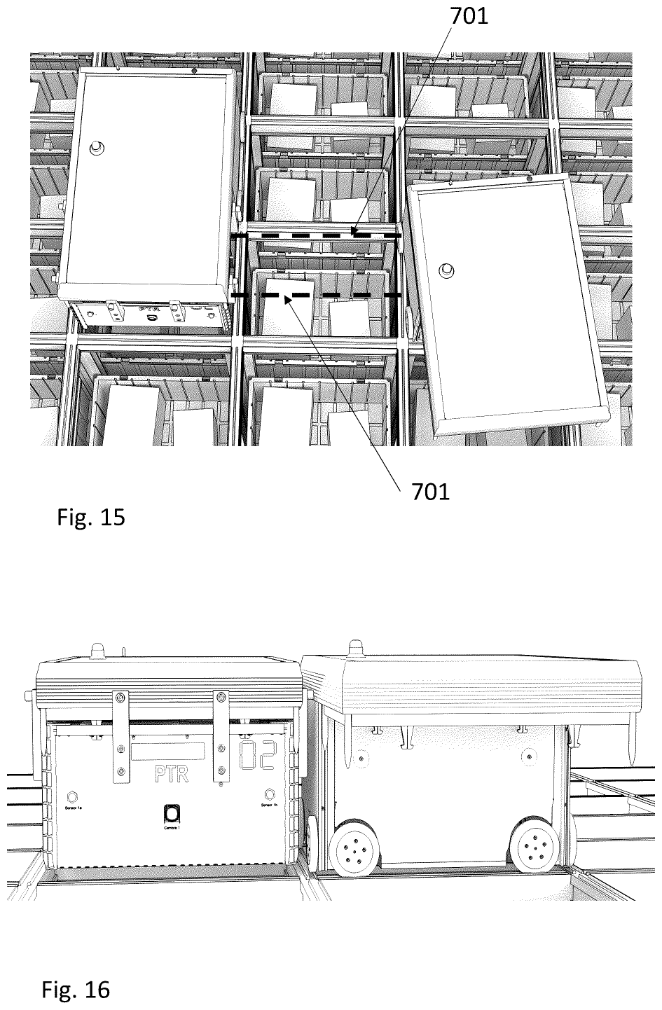

FIG. 15 is a top view of the tool being used to assess the position of a faulty first container handling vehicle while it is being carried by another container handling vehicle.

FIG. 16 is a front view of the tool being used for pushing the faulty first container handling vehicle sideways to a known location.

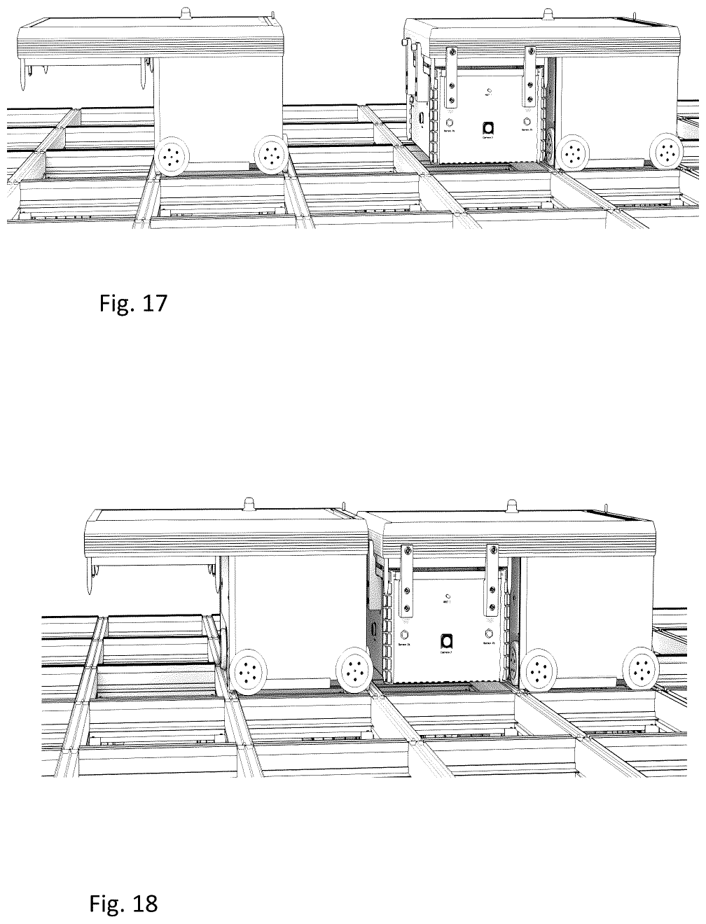

FIG. 17 is a side view of the tool being used to estimate the position of a faulty first container handling vehicle in front of the tool.

FIG. 18 is a side view of the tool being used to push the faulty first container handling vehicle to a known location.

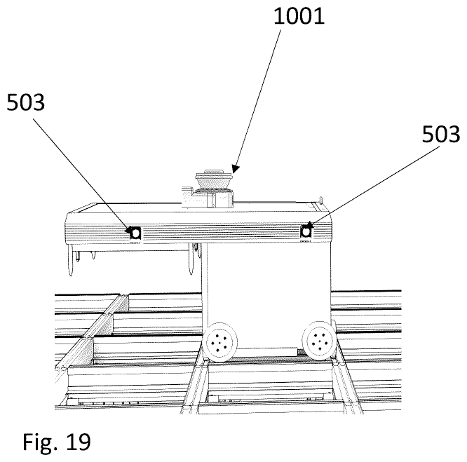

FIG. 19 is a side view of a container handling vehicle that har sensors and lidar mounted to it.

### DETAILED DESCRIPTION

In the following, embodiments of the invention will be discussed in more detail with reference to the appended drawings. It should be understood, however, that the drawings are not intended to limit the invention to the subject-matter depicted in the drawings.

The framework structure 100 of the automated storage and retrieval system 1 is constructed in accordance with the prior art framework structure 100 described above in connection with FIGS. 1-3, i.e. a number of upright members 102 and a number of horizontal members 103, which are supported by the upright members 102, and further that the framework structure 100 comprises a first, upper rail system 108 in the X direction and Y direction.

The framework structure 100 further comprises storage compartments in the form of storage columns 105 provided between the members 102, 103, where storage containers 106 are stackable in stacks 107 within the storage columns 105.

The framework structure 100 can be of any size. In particular it is understood that the framework structure can be considerably wider and/or longer and/or deeper than disclosed in FIG. 1. For example, the framework structure 100 may have a horizontal extent of more than 700×700 columns and a storage depth of more than twelve containers.

In FIG. 4 an upwardly perspective view of a central cavity solution container handling vehicle is shown. in this image, and the lifting platform is lowered. This lifting platform has guiders 404 in order to help the lifting platform to connect properly with the containers in the storage columns.

Further it can be seen that the container handling vehicle has a footprint that is larger than a column. The extra space can be used to store batteries, electronics and communication equipment etc.

Although the present invention is designed to be carried by a container handling vehicle with a cantilever solution, the tool can be used to detect container handling vehicles with a central cavity solution.

The tool in this invention is in the shape of a container used in the storage and retrieval unit to store items. The container has a box shape with four sides and a bottom. Further, similar to the containers for storage used in the storage and retrieval system the tool has areas for receiving the grippers from the lifting platform of the container handling vehicle so that the tool can be lifted securely by the container handling vehicle.

The tool support fixtures in this invention can be in the form of a continuous edge around the top of the tool. Alternative it can be an edge that follows the length of each side to the corner guide.

One embodiment of the automated storage and retrieval system according to the invention will now be discussed in more detail with reference to FIGS. 5-18.

FIG. 5 is a perspective view of an embodiment of the present invention displaying the tool for detecting the positioning of a faulty first container handling vehicle on a grid-based rail system of an automated storage and retrieval system.

This one embodiment of the present invention displays a tool that has the shape of a container. The tool is of a box shape with four sides and a bottom. In this image there is no lid or top on the tool, but a lid or a top side can be used in this embodiment without any changes to the operation or use of the tool.

On each side of the tool there is mounted at least one bumper. These tool support fixtures are used as a barrier between the faulty (first) container handling vehicle, and the vehicle carrying the tool, after it has been located and helps prevent the containers from bumping into each other and causing damage to each other. Further these tool support fixtures can be used as rests that ensure that the tool is kept at the right level when it is placed on the grid in order to detect the faulty (first) container handling vehicle.

Further we can see that each of the sides of the tool that extend outwardly from under the cantilever arm of the container handling vehicle has a sensor. The sensor can be a camera. But, also any other sensor that can be used to locating a stalled container handling vehicle and determining the distance to it. In an embodiment of this invention there can be a camera in addition to at least one sensor on each side of the tool. The camera can be used to locate the stalled container handling vehicle and the sensor can be used to e.g. determine the distance. In one configuration, a pair of distance sensors are positioned on either side of a camera. This however can be changed without compromising the operability of the tool. The camera can be used as the only sensor for detecting the faulty container handling vehicle(s), or the camera can be used in addition to one or more sensors for detecting the position of the faulty container handling vehicle, e.g., through the use of image analysis to determine a positions on the grid.

The shape of the tool is such that it will fit into the opening of a column on the grid. The tool is then lowered into a column until it rests on the tool support fixtures. The bottom of the tool support fixtures rest on the rails that provide the frame of horizontal members around the opening of the column that the tool is placed in. The fuller extent of these horizontal members provides the grid of the storage and retrieval system.

At the top of the tool support fixtures is placed a contact member. This knob is the only place where the tool interacts with the faulty container handling vehicle.

There can be one or more tool support fixtures on each side of the container handling vehicle. In the image presented in FIG. 5 there are two tool support fixtures on each of the sides that are intended to make contact with a faulty container handling vehicle.

In this image it is also possible to see that there is a radio antenna on at least one side of this embodiment of the present invention. This allows the tool to receive and send instructions to both the container handling vehicle that carries it and/or to the central computer system that keeps track of the entire storage and retrieval system.

In an alternative solution the antenna can be placed within the tool.

Further the radio antenna makes it possible for the tool to communicate the measurements from the sensors and/or the cameras to the container handling vehicle and/or the central computer system.

In a further solution the antenna makes it possible to communicate with the faulty container handling vehicle.

Also, the antenna can be used to communicate with other similar tools that have been placed on the grid. This allows the tools to use triangulation to determine the distance and the location of the faulty container handling vehicle. The triangulation signal can be sent both from the tool in order to be picked up by the faulty container handling vehicle, and it can be used to receive a triangulation signal from the faulty container handling vehicle.

FIG. 6 is a perspective view of the embodiment from FIG. 5 displaying the equipment inside the tool. In this image the tool is placed inside a column opening. As can be seen the tool fits into the opening of a column. The tool support fixtures, which is fixed to the sides of the tool, ensures that the tool rest at the correct height in the opening of the grid cell. The tool support fixtures extend from the sides of the tool to the mid-point of the rails. At the maximum extent the bumper and the contact members extend the width of the rails.

Inside the tool there is a controller box 601, the controller box controls the operation of the tool and the communication between the tool and the container handling vehicles and the central computer system. The operation of the tool includes gathering data from the sensors in order to find a faulty container handling vehicle. It can also perform the analysis and evaluation of the gathered data.

The controller box is powered by at least one power source. The power source can be a battery or a capacitor or both. The power source can be stored inside the tool along with the controller box. Further the power source(s) can be charged by a charger at a charger station where the tool is stored when it is not in use. Alternatively, the power source in the tool can be charged by the battery of the container handling vehicle, e.g., through electrical or inductive coupling of the container handling vehicle's lifting device when it is supplied by power from the battery of the container handling vehicle. It is also possible to have both charging solutions on the tool, for example, contacts for when the tool is placed at a charging station and contacts adjacent the formations for connection to the lifting device.

Further it is possible to see the plastic corner guides in the image. The plastic corner guides are constructed in a way that makes it easier for the tool to be guided into a column opening. Also, the corner guides have a rounded or flat shape facing the corner of the column opening in order to reduce the risk of the tool getting stuck in the opening of the column.

It is also possible to see the wiring from the controller to both the batteries and the sensors and the antennas.

In FIG. 6 the tool only has tool support fixtures on three sides. This is to ensure that the side that is closest to the body of the container handling vehicle does not have tool support fixtures that can entangle with the inside of the cantilever of the container handling vehicle.

However, if the height of the tool support fixtures is under a certain level there can be tool support fixtures on all the sides of the tool, as shown in FIG. 5.

FIG. 7 is a perspective view of the tool according to the embodiment in FIG. 5 being carried by a container handling vehicle to a destination close to the area where a faulty container handling vehicle has faulty. Here a container handling vehicle with a cantilever solution is shown carrying the tool to a position on the grid. In this solution the data from the sensors is collected when the container handling vehicle carries the tool. When the data is collected from the sensors the calculation and analysis of the data is performed and if the position of the faulty container handling vehicle is established the container handling vehicle carrying the tool can use the tool to push the faulty container handling vehicle either to a location known to the central computer system or to a service area.

The solution presented in FIGS. 5-8 is only able to use the sensors and/or the cameras when the tool is carried by a container handling vehicle. Due to the tool support fixtures being positioned above the level of the sensors and the cameras the collection of the data from the sensors and the cameras is not possible due to the fact that they will be below the surface of the grid. The tool may be configured so that when it is placed on the grid the tool will revert to a sleep mode and then switch to an active mode when picked up by a container handling vehicle.

However, if the tool support fixtures are longer, the tool can be placed on the grid and data form the sensors can be collected. For example, the tool can also be fitted with tool support fixtures that extend below the level of the sensors and the camera in order to perform the collection of data from the sensors.

FIG. 8 is a perspective view of the embodiment of the present invention according to FIG. 5 where the tool is placed in the grid of the automated storage and retrieval system. This is an example of the tool being placed in a sleeping state on the grid. In this state the tool is waiting for orders from the central computer system and a container handling vehicle to pick up the tool. Since the antenna is placed above the surface of the grid the tool could potentially be used for triangulation of signals either from the faulty container handling vehicle to send signals to the faulty container handling vehicle that it can use to find its location.

In a scenario a tool can be placed on the grid and be in sleep mode until the central computer system tells it to wake up and search for a faulty container handling vehicle.

The tool uses the antenna to find the rough location of the faulty container handling vehicle. After the rough location of the faulty container handling vehicle has been established, a different container handling vehicle is sent to pick the tool up. That container handling vehicle carries the tool over to the area where the initial gathered data showed the faulty container handling vehicle to be. When there, the tool uses its sensors and/or camera to get a detailed position of where the faulty container handling vehicle is. The container handling vehicle carrying the tool may then use the tool to push the faulty container handling vehicle to a known location where it can start up again or to a service area where it can be fixed if the faulty container handling vehicle is not able to be started up again.

When the procedure is finished the tool is placed back in sleep mode.

FIG. 9 is a perspective view of an embodiment of the present invention according to FIG. 5 wherein the tool is placed in the grid of the automated storage and retrieval system.

Here it can be seen a first container handling vehicle that is faulty on the grid. The reason for the break down appears to be due to derailing. The derailing causes the container handling vehicle and the central computer system to not know the exact position of the faulty container handling vehicle.

In an embodiment of the present invention the tool can be stored on the grid, like illustrated in this figure or it can be stored in a specially dedicated location. In this scenario the central computer system will send instructions to an available, e.g., second, container handling vehicle and ask it to pick up the tool from where it is stored. This second container handling vehicle picks up the tool and transports it to a position close to the last known location of the faulty first container handling vehicle.

When the second container handling vehicle has reached its destination, the tool is told to perform measurements. When the data from the measurements is collected the data can be sent to the central computer system and processed in order to find the location of the faulty first container handling vehicle. The data can also be transferred in real time to the central computer system and processed continuously.

When the data is processed and the faulty first container handling vehicle is located, the central computer system sends instructions to the second container handling vehicle to push the faulty first container handling vehicle to either a known location on the grid or to a service station After the faulty first container handling vehicle is transported to the right location the tool can be transported to its proper location.

FIG. 10 is a side view of another embodiment of the present invention wherein the tool is carried by a container handling vehicle.

In this embodiment the second container handling vehicle is carrying a slightly different embodiment of the present invention. Here the tool has longer tool support fixtures which makes it possible for the sensors on the sides of the tool to be above the level of the grid when the tool is placed on the grid.

Further an additional sensor is attached to the tool. In this embodiment there is a lidar 1001 attached to the bottom of the tool. This is attached so that the light from the lidar spreads outwards in front and to the sides of the container handling vehicle.

FIG. 11 is a perspective view of the present invention according to the embodiment from FIG. 10 wherein the tool is carried by a container handling vehicle when performing the measurements.

Here the measurements performed by the tool are performed while the container handling vehicle is carrying the tool. The light from the lidar is shown as radiating from the tool in a fan-like shape.

The faulty first container handling vehicle is in the search area of the lidar and it is detected. The second container handling vehicle can use the tool support fixtures on the tool to push the faulty first container handling vehicle to a known location on the grid or to a service area.

FIG. 12 is a side view of a third another embodiment of the present invention wherein the tool is carried by a container handling vehicle while performing the measurements.

Here it is displayed a third embodiment of the present invention. It can be seen that the tool has a set of feet attached to the tool. The feet allow the tool to be placed on top of the grid. By placing the tool on top of the grid by using feet, it allows the use of the lidar attached to the underside of the tool.

It also allows for the other sensors to be elevated above the grid. This can make it easier for the sensors to find the faulty first container handling vehicle. Especially the camera can benefit from being elevated above the grid giving it a better line sight. Also, by elevating the tool by using feet the it is possible to use just one lidar and get a wide search area. If the lidars are placed on the sides of the tool each lidar would have a smaller search area and it would require more lidars making the tool more expensive. However, this is also a possible solution to the present invention.

FIG. 13 is a side view of the embodiment of the present invention from FIG. 12 wherein the tool is positioned on the grid of the automated storage and retrieval system. Here the tool is placed on the grid using feet to elevate the tool above surface of the grid. It is possible here to see the lidar attached to the bottom of the tool. The lidar further has a free line of sight forward and to the sides of the container handling vehicle.

FIG. 14 is a perspective view of the third embodiment of the present invention wherein the tool is placed on the grid of the automated storage and retrieval system while the tool is performing the measurements. The light from the lidar is here shown radiating from the tool in a fan like shape. If there is something in the path of the light from the lidar, it is bounced back to the lidar and it is possible to calculate the shape, position, and distance to the obstacle from the light received by the lidar.

FIG. 15 is a top view of the tool being used to assess the position of a faulty first container handling vehicle while it is being carried by another container handling vehicle.

This is an image of a method for using the tool. Here the tool is carried by a second container handling vehicle. The tool uses its sensors to estimate the distance and position of the faulty first container handling vehicle.

FIG. 16 is a front view of the tool being used for pushing the faulty first container handling vehicle sideways to a known location. When the tool in FIG. 15 has located the faulty first container handling vehicle the second container handling vehicle uses the tool to push the faulty first container handling vehicle using the contact members mounted on the tool support fixtures of the tool. As displayed in this image the second container handling vehicle can use the tool to push the faulty first container handling vehicle from the sides.

FIG. 17 is a side view of the tool being used to estimate the position of a faulty first container handling vehicle in front of the tool.

Here it is displayed that the tool also can be used to locate a container handling vehicle positioned in front of it. The tool can be used to push the faulty first container handling vehicle from the back as is shown in FIG. 18.

Further, in order to maneuver the faulty first container handling vehicle to e.g. a service station, in case the faulty first container handling vehicle will not start, the second container handling vehicle needs to be able to use the tool to push the faulty first container handling from all three sides.

FIG. 19 is a side view of a container handling vehicle that har sensors and lidar mounted to it.

In this embodiment there is a lidar 1001 attached to the top of the second container handling vehicle. This is attached so that the light from the lidar spreads outwards in all directions of the container handling vehicle.

The second container handling vehicle has at least one sensor on each vertical side. The sensor can be a camera. But also, any other sensor that can be used to locating a stalled first container handling vehicle and determining the distance to it. In an embodiment of this invention there can be at least one camera in addition to at least one sensor on each side of the container handling vehicle. The camera can be used to locate the stalled container handling vehicle and the sensor can be used to e.g. determine the distance. In one configuration, a pair of distance sensors are positioned on either side of a camera. This however can be changed without compromising the operability of the container handling vehicle. The camera can be used as the only sensor for detecting the faulty container handling vehicle(s), or the camera can be used in addition to one or more sensors for detecting the position of the faulty container handling vehicle, e.g., through the use of image analysis to determine a positions on the grid.

In the preceding description, various aspects of the delivery vehicle and the automated storage and retrieval system according to the invention have been described with reference to the illustrative embodiment. For purposes of explanation, specific numbers, systems, and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

### Prior Art (FIGS. 1-4):

1 Prior art automated storage and retrieval system
100 Framework structure
102 Upright members of framework structure
103 Horizontal members of framework structure
104 Storage grid
105 Storage column
106 Storage container
106′ Particular position of storage container
107 Stack
108 Rail system
110 Parallel rails in first direction (X)
110a First rail in first direction (X)
110b Second rail in first direction (X)
111 Parallel rail in second direction (Y)
111a First rail of second direction (Y)
111b Second rail of second direction (Y)
112 Access opening
119 First port column
120 Second port column
201 Prior art container handling vehicle
201a Vehicle body of the container handling vehicle 201
201b Drive means/wheel arrangement, first direction (X)
201c Drive means/wheel arrangement, second direction (Y)
301 Prior art cantilever container handling vehicle
301a Vehicle body of the container handling vehicle 301
301b Drive means in first direction (X)
301c Drive means in second direction (Y)
401 Prior art container handling vehicle
401a Vehicle body of the container handling vehicle 401
401b Drive means in first direction (X)
401c Drive means in second direction (Y)
501 Tool support fixture
502 Contact member
503 Camera
504 Distance sensor
505 Corner guide
506 Side of the container
507 Antenna
601 Controller box
602 Battery
603 Sensor cable
701 Sensor measuring distance to
1001 Lidar
1201 Feet.
X First Direction
Y Second direction
Z Third direction

1. A tool for detecting the positioning of a first container handling vehicle on a grid-based rail system of an automated storage and retrieval system, the rail system being part of a framework structure where the rail system comprises a first set of parallel rails arranged to guide movement of container handling vehicles in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members that define storage columns for storing containers within the framework structure, characterized in that the tool comprises an upper surface provided with formations to allow the tool to be picked up by a lifting device of a second container handling vehicle working on the rail system, the tool including a sensor for detecting the positioning of the first container handling vehicle on the rail system.

2. A tool according to claim 1, wherein the sensor for determining the positioning of a first container handling vehicle is placed on a side or the bottom surface of the tool.

3. A tool according to claim 1, wherein the sensor can be a camera, a lidar, a proximity sensor or any other type of sensor capable of detecting objects surrounding it.

4. A tool according to claim 1, wherein there can be more than one sensor attached to the tool.

5. A tool according to claim 1, wherein the tool has tool support fixtures on at least one side for pushing the first container handling vehicle to a known location.

6. A tool according to claim 1, wherein the tool has a wireless communication device, a power source, and a controller for performing measurements and communicating with a central computer system.

7. A tool according to claim 1, wherein the tool has a set of legs allowing the tool to be placed on the grid.

8. A tool according to claim 1, wherein the tool support fixtures rest on the rails around the grid cell when the tool is lowered into a grid cell.

9. A tool according to claim 1, wherein the tool has feet attached to it that rest in the tracks around the grid cell when the tool is placed on the grid.

10. A method for detecting the positioning of a first container handling vehicle on a grid-based rail system of an automated storage and retrieval system, the rail system being part of a framework structure, the rail system comprising a first set of parallel rails arranged to guide movement of container handling vehicles in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members that define storage columns for storing containers within the framework structure, the method comprising:
picking up the tool using a lifting device of a second container handling vehicle working on the rail system,
transporting the tool to a location at least one cell away from the last known location of the first container handling vehicle,
using the tool to determine the positioning of the first container handling vehicle, and
telling the second container handling vehicle carrying the tool to place the tool back to its storage place.

11. The method according to claim 10, wherein the tool is placed and used on the grid to monitor the situation in the rail system.

12. The method according to claim 11, wherein a plurality of tools is placed around the grid.

13. A system for detecting the positioning of a first container handling vehicle on a grid-based rail system of an automated storage and retrieval system, the rail system being part of a framework structure where the rail system comprises a first set of parallel rails arranged to guide movement of container handling vehicles in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members that define storage columns for storing containers within the framework structure, characterized in that
the system comprises a tool according to claim 1;
wherein the tool can be carried by a container handling vehicle.

14. A computer program product comprising instructions which run on a computer which controls a system for detecting the positioning of a first container handling vehicle on a grid-based rail system of an automated storage and retrieval system:
wherein the rail system is part of a framework structure where the rail system comprises a first set of parallel rails arranged to guide movement of container handling vehicles in a first direction across the top of the framework structure, and a second set of parallel rails arranged perpendicular to the first set of rails to guide movement of the container handling vehicle in a second direction which is perpendicular to the first direction, the first and second sets of parallel rails dividing the rail system into a plurality of grid cells, the framework structure comprising upright members that define storage columns for storing containers within the framework structure;
wherein the system for detecting the positioning of the first container handling vehicle comprises a tool as recited in claim 1 that can be carried by a container handling vehicle;
wherein executing the instructions results in commands being sent to:
instruct the second container handling vehicle to pick up the tool using a lifting device of the second container handling vehicle working on the rail system,
instruct the second container handling vehicle to transports the tool to a location at least one cell away from the last known location of the first faulty container handling vehicle,
instruct the second container handling vehicle using the tool to determine the positioning of the first faulty container handling vehicle, and
instruct the second container handling vehicle carrying the tool to place the tool back to its storage place.

15. The system of claim 13, wherein the sensor for determining the positioning of a first container handling vehicle is placed on a side or the bottom surface of the tool.

16. The system of claim 13, wherein the sensor can be a camera, a lidar, a proximity sensor or any other type of sensor capable of detecting objects surrounding it.

17. The system of claim 13, wherein there can be more than one sensor attached to the tool.

18. The system of claim 13, wherein the tool has tool support fixtures on at least one side for pushing the first container handling vehicle to a known location.

19. The system of claim 13, wherein the tool has a wireless communication device, a power source, and a controller for performing measurements and communicating with a central computer system.

20. The system of claim 13, wherein the tool has a set of legs allowing the tool to be placed on the grid.
